(19) United States
(12) Patent Application Publication
(10) Pub. No.: US 2026/0168919 A1
(43) Pub. Date: Jun. 18, 2026

(54) Measurement Device and Measurement Method For Concentration of Hemoglobin

(71) Applicant: South China University of Technology, Guangzhou, Guangdong (CN)

(72) Inventors: Qilai ZHAO, Guangzhou, Guangdong (CN); Shanhui XU, Guangzhou, Guangdong (CN); Chunlan DENG, Guangzhou, Guangdong (CN); Changsheng YANG, Guangzhou, Guangdong (CN); Zhouming FENG, Guangzhou, Guangdong (CN); Zhongmin YANG, Guangzhou, Guangdong (CN)

(73) Assignee: South China University of Technology, Guangzhou, Guangdong (CN)

(21) Appl. No.: 18/710,571

(22) PCT Filed: Nov. 8, 2022
(86) PCT No.: PCT/CN2022/130626

§ 371 Date: May 15, 2024

(30) Foreign Application Priority Data
Nov. 16, 2021 (CN) 202111353297.6

(51) Int. Cl. G01N 21/31; G01N 21/01

(52) U.S. Cl. CPC G01N 21/31; G01N 21/01; G01N 2201/06113

(57) ABSTRACT

A hemoglobin concentration measurement apparatus and measurement method. The measurement apparatus comprises: a single-frequency optical fiber laser (1), which is used for outputting single-path laser light; a light-splitting coupler (2), which is connected to the single-frequency optical fiber laser (1), and is used for splitting the output single-path laser light into two paths of laser light; a first photoelectric detector (4), which is used for receiving measurement light transmitting through a sample cell (3), and outputting a first voltage; a second photoelectric detector (5), which is used for receiving reference light, and outputting a second voltage; and a signal collection and processing system (6), which is used for receiving the first voltage and the second voltage, and acquiring the concentration of a hemoglobin solution according to the first voltage and the second voltage. A hemoglobin solution to be tested is irradiated by using laser light, and the concentration of the hemoglobin solution is solved according to an absorbance; a measurement process is simple and convenient, non-toxic and pollution-free, and the measurement efficiency is high, and the stability is good, such that a hemoglobin concentration can be continuously measured in real time; and the present invention can lay a foundation for non-invasive measurement, and can be widely applied to the field of liquid concentration measurement.

### TECHNICAL FIELD

The present disclosure relates to the field of measuring liquid concentration, and in particular to a measurement device and measurement method for a concentration of hemoglobin.

### BACKGROUND

Currently, commonly used measurement methods for a concentration of hemoglobin include photometry method, fluorometry method, and electrochemical method. The principle of traditional photometry method is to generate a stable chromogenic substance mainly based on the interreaction between hemoglobin and certain actual substances, and then calculate the concentration of the hemoglobin through characteristic absorption of light by this chromogenic substance at a specific wavelength. The existing method is to react hemoglobin with potassium ferricyanide to generate stable hemiglobincyanide (HiCN), select a suitable wavelength to illuminate HiCN to measure a light intensity, and finally calculate the concentration of hemoglobin. This method has good accuracy in measurement results, but the chemical reagents used therein have certain toxicity and are prone to cause harm to the body and cause environmental pollution. In addition, a measurement light source used in the traditional photometry method is generally a tungsten halogen lamp, supplemented by monochromator, grating or other optical elements to achieve single wavelength selection and light output. However, the measurement light source used is complex in structure, and it is difficult to greatly improve the stability, monochromaticity and directionality of the light source, thus affecting the accuracy and sensitivity of a measurement result.

Because hemoglobin has a high catalytic activity similar to peroxidase, in the fluorometry method, a suitable enzyme-catalyzed oxidation substrate is selected to fully react with the hemoglobin, a fluorescence analysis is then performed on the product, and the concentration of hemoglobin is calculated. However, this method is cumbersome and complex in measurement process, cannot perform analysis and measurement rapidly in real time, and is difficult to be used in clinical testing.

The basic principle of the electrochemical method is the oxidation-reduction reaction of hemoglobin. Since hemoglobin easily absorbs quartz and undergoes an oxidation-reduction reaction, and the concentration of hemoglobin is directly proportional to the current of the oxidation-reduction reaction, the concentration of hemoglobin can be obtained by measuring the current value. Analysis and detection can be performed in real time rapidly by this method. However, hemoglobin with large structure may adhere to the surface of an electrode, gradually passivating the electrode and affecting the accuracy of measurement results.

### SUMMARY

In order to solve one of the technical problems existing in the prior art at least to a certain extent, the objective of the present disclosure is to provide a measurement device and measurement method for hemoglobin based on a single-frequency fiber laser.

The technical solution used in the present disclosure is as below.

A device for measuring a concentration of hemoglobin, including:
a single-frequency fiber laser configured for outputting a single-path laser;
a light-splitting coupler connected to the single-frequency fiber laser and configured for splitting the single-path laser output into two paths of laser, where one path of laser is a measurement light, and the other path of laser is a reference light;
a first photodetector configured for receiving the measurement light transmitting through a sample cell and outputting a first voltage, wherein the sample cell contains a hemoglobin solution;
a second photodetector configured for receiving the reference light and outputting a second voltage; and
a signal collection and processing system electrically connected to the first photodetector and the second photodetector, and configured for receiving the first voltage and the second voltage and acquiring the concentration of the hemoglobin solution according to the first voltage and the second voltage.

Further, the single-frequency fiber laser includes a pumping source, an fiber laser resonator, a wavelength division multiplexer, an optical isolation filter, an fiber amplifier and a frequency doubling module which are connected in sequence; and
the pumping source emits pumping light into the fiber laser resonator to generate a stimulated radiation laser signal, and the stimulated radiation laser signal passes through the wavelength division multiplexer and the optical isolation filter and then undergoes power amplification by the fiber amplifier and frequency nonlinear conversion by the frequency doubling module to output a single-frequency fiber laser.

Further, the single-frequency fiber laser further includes a phase modulator, an input of the phase modulator is connected to an output of the optical isolation filter, and an output of the phase modulator is connected to an input of the fiber amplifier; and
the phase modulator is configured for phase modulating a laser signal output by the optical isolation filter.

Further, the fiber laser resonator is additionally provided with a piezoelectric ceramic configured for phase modulating an output light of the fiber laser resonator.

Further, the pumping source has a working wavelength of 976 nm, the fiber laser resonator has a central wavelength of 1080 nm, and the frequency doubling module outputs a single-frequency fiber laser with a wavelength of 540 nm.

Further, a frequency doubling crystal in the frequency doubling module is a lithium niobate crystal, a magnesium oxide-doped lithium niobate crystal, a lithium tantalate crystal, a lithium triborate crystal, a barium metaborate crystal, a potassium dihydrogen phosphate crystal or a potassium titanyl phosphate crystal.

Further, a wavelength range of an output light of the single-frequency fiber laser is 450 nm to 580 nm.

Another technical solution used in the present disclosure is as below.

A measurement method for a concentration of hemoglobin, including following steps:
acquiring two paths of single-frequency laser, where one path of laser is used as a measurement light, and the other path of laser is used as a reference light;
transmitting the measurement light through a sample cell containing a hemoglobin solution, collecting a transmitted measurement light, and acquiring a first voltage according to a collected measurement light;
acquiring a second voltage according to the reference light; and
acquiring the concentration of the hemoglobin solution according to the first voltage and the second voltage.

Further, the step of acquiring the concentration of the hemoglobin solution according to the first voltage and the second voltage, including:
calculating an absorbance of the hemoglobin solution to the measurement light according to the first voltage and the second voltage; and
acquiring the concentration of the hemoglobin solution according to the absorbance and a preset relational expression.

Further, the preset relational expression is obtained in the following manner:
providing a sample cell having a constant thickness;
filling a hemoglobin solution with a preset concentration into the sample cell, collecting the reference light and the measurement light transmitting through the sample cell, and calculating an absorbance corresponding to the hemoglobin solution with the preset concentration according to collected measurement light and reference light; and
by changing concentrations of hemoglobin solutions, acquiring absorbances corresponding to the hemoglobin solutions at different concentrations, and obtaining the relational expression.

The present disclosure has the below beneficial effects.

According to the present disclosure, based on the Lambert-Beer law, a hemoglobin solution to be measured is irradiated by a laser, and the concentration of the hemoglobin solution is calculated according to the absorbance of the hemoglobin solution to the laser. The measurement process is simple, non-toxic and pollution-free, and is high in measurement efficiency and good in stability, so that the concentration of hemoglobin can be continuously detected in real time, which may lay a foundation for non-invasive measurement.

### BRIEF DESCRIPTION OF DRAWINGS

In order to explain the technical solutions in the embodiments of the present disclosure or in the prior art more clearly, the drawings of the relevant technical solutions in the embodiments of the present disclosure or in the prior art will be introduced below. It should be understood that the drawings in the following introduction are only for the convenience of clearly describing some embodiments in the technical solutions of the present disclosure, and those skilled in the art can also obtain other drawings based on these drawings without creative efforts.

FIG. 1 is a schematic structural diagram of a measurement device for a concentration of hemoglobin in an embodiment of the present disclosure;

FIG. 2 is a schematic structural diagram of a single-frequency fiber laser in an embodiment of the present disclosure;

FIG. 3 is a schematic diagram of a visible light absorption spectrum of hemoglobin in an embodiment of the present disclosure;

FIG. 4 is a least squares fitting curve of a relationship between absorbance and concentration in an embodiment of the present disclosure;

FIG. 5 is a flow chart of a measurement method for a concentration of hemoglobin in an embodiment of the present disclosure; and

FIG. 6 is a flow chart for calculating a concentration of a hemoglobin solution in an embodiment of the present disclosure.

Reference numerals: 1—Single—frequency fiber laser, 2—Light—splitting coupler, 3—Sample cell, 4—First photodetector, 5—Second photodetector, 6—Signal collection and processing system, 11—Pumping source, 12—Fiber laser resonator, 13—Wavelength division multiplexer, 14—Optical isolation filter, 15—Phase modulator, 16—Fiber amplifier, 17—Frequency doubling module.

### DETAILED DESCRIPTION

Embodiments of the present invention will be described in detail below. Examples of the embodiments are shown in the Figures in which the same or similar reference numerals refer to same or similar elements or elements having same or similar functions. The embodiments described below with reference to the Figures are exemplary and are only used to explain the present disclosure and cannot be understood as limiting the present disclosure. The step numbers in the following embodiments are only set for the convenience of explanation. The order of the steps is not limited in any way. The execution order of each step in the embodiments can be adjusted adaptively according to the understanding of those skilled in the art.

In the description of the present disclosure, it should be understood in the description concerning direction, terms such as “up”, “down”, “front”, “back”, “left”, “right”, etc. indicate direction or position relationships shown based on the drawings, and are only intended to facilitate the description of the present disclosure and the simplification of the description rather than to indicate or imply that the indicated device or element must have a specific direction, be constructed and operated in a specific direction, and therefore, shall not be understood as a limitation to the present disclosure.

In the description of the present disclosure, it should be noted that “several” means one or more, “plural” (or multiple) means more than two; “more than”, “less than”, “exceed”, etc. are understood to exclude the number itself; and “no less than”, “no more than”, “within”, etc. are understood to include the number itself. The description of “first”, “second”, etc. is only for the purpose of distinguishing technical features, and cannot be understood as indicating or implying relative importance or implying the quantity or order of the indicated technical features.

In the description of the present disclosure, unless otherwise explicitly defined, words such as “providing”, “arranging”, “connection”, etc. should be understood in a broad sense. Those skilled in the art can reasonably determine the specific meaning of the above words in the present disclosure in conjunction with the specific content of the technical solution.

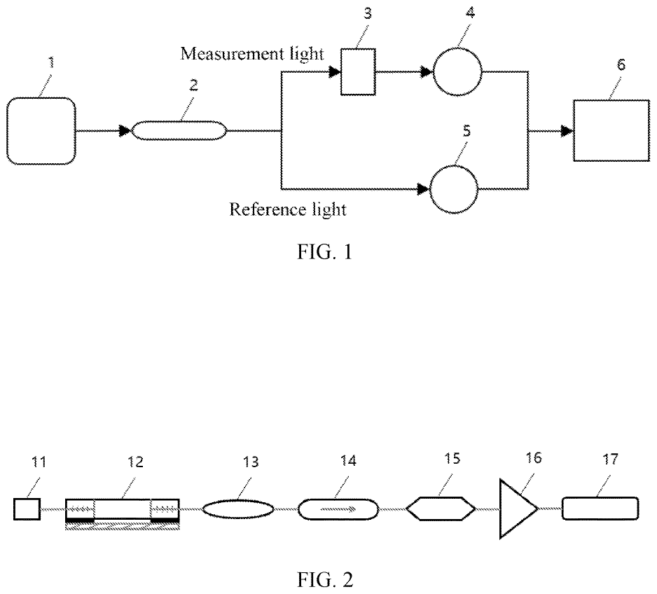

As shown in FIG. 1, this example provides a measurement device for a concentration of
a single-frequency fiber laser 1 configured for outputting a single-path laser;
a light-splitting coupler 2 connected to the single-frequency fiber laser 1 and configured for splitting the single-path laser output into two paths of laser, where one path of laser is a measurement light, and the other path of laser is a reference light;
a first photodetector 4 configured for receiving the measurement light transmitting through a sample cell 3 and outputting a first voltage, where the sample cell 3 contains a hemoglobin solution;
a second photodetector 5 configured for receiving the reference light and outputting a second voltage; and
a signal collection and processing system 6 electrically connected to the first photodetector 4 and the second photodetector 5, and configured for receiving the first voltage and the second voltage and acquiring the concentration of the hemoglobin solution according to the first voltage and the second voltage.

The device of this example uses Lambert-Beer law as a theoretical basis for measurement, uses the single-frequency fiber laser 1 as a measurement light source, measures the absorbance of the hemoglobin solution, and quantitatively determines the concentration of hemoglobin in a sample. The measurement light source is of a fully polarization-maintaining structure, and the output light has excellent monochromaticity and directionality, which can improve the accuracy and reliability of a measurement result. The specific working principle of the above device is as follows: the single-frequency fiber laser 1 generates and emits laser. In view of the characteristics of the hemoglobin solution, in this example, the wavelength range of the output light is selected to be 450 nm to 580 nm, pure single-frequency fiber laser of a blue-green light band is output, and a power range is 1 μW to 1 W. After being emitted, the laser is split into two paths of laser by the light-splitting coupler 2. As an optional implementation, the two paths of laser have the same light intensity. One path of laser of the two paths of laser is used as a measurement light, and the other path of laser is used as a reference light, where the reference light split by the light-splitting coupler 2 may reflect the tiny fluctuation of the light source in real time. After being vertically incident on the sample to be measured placed in the sample cell 3, the measurement light is received by the first photodetector 4 and converted into an electrical signal, the reference light is directly received by the second photodetector 5 and converted into an electrical signal, and the electrical signals are processed and converted by the dual-channel signal collection and processing system 6, obtaining an accurate concentration value of hemoglobin. In summary, it can be seen that the device is simple in structure and convenient to operate, and it only requires to put the hemoglobin solution to be measured into the sample cell 3 during the measurement. Moreover, the device has no pollutants generated during the measurement process, is high in measurement efficiency, accurate in measurement result, and good in stability, so the concentration of hemoglobin can be continuously detected in real time.

Referring to FIG. 2, as an optional implementation, the single-frequency fiber laser 1 includes a pumping source 11, an fiber laser resonator 12, a wavelength division multiplexer 13, an optical isolation filter 14, an fiber amplifier 16 and a frequency doubling module 17 which are connected in sequence; and
the pumping source 11 emits a pumping light into the fiber laser resonator 12 to generate a stimulated radiation laser signal, and the laser signal passes through the wavelength division multiplexer 13 and the optical isolation filter 14 and then undergoes power amplification by the fiber amplifier 16 and frequency modulation by the frequency doubling module 17 to output a single-frequency fiber laser.

The connection relationships of all elements in the single-frequency fiber laser 1 are as follows:
the pumping source 11 is connected to a broadband fiber grating of the fiber laser resonator 12, a narrowband fiber grating of the fiber laser resonator 12 is connected to the wavelength division multiplexer 13, the wavelength division multiplexer 13 is connected to the optical isolation filter 14, the optical isolation filter 14 is connected to the fiber amplifier 16, the fiber amplifier 16 is connected to the frequency doubling module 17, and the frequency doubling module 17 is connected to the light-splitting coupler 2. A frequency doubling crystal in the frequency doubling module 17 is a lithium niobate (LN) crystal, a magnesium oxide-doped lithium niobate (MgO:LN) crystal, a lithium tantalate (LT) crystal, a lithium triborate (LBO) crystal, a barium metaborate (BBO) crystal, a potassium dihydrogen phosphate (KDP) crystal or a potassium titanyl phosphate (KTP) crystal.

Referring to FIG. 2, as an optional implementation, the single-frequency fiber laser 1 further includes a phase modulator 15 configured for phase modulating the laser signal output by the optical isolation filter 14. The fiber laser resonator 12 is additionally provided with a piezoelectric ceramic configured for phase modulating the output light of the fiber laser resonator.

When not being phase modulated, the output light of the single-frequency fiber laser 1 is suitable for measuring samples to be measured with higher concentrations and narrower concentration ranges. In this example, by one of the piezoelectric ceramic and the phase modulator 15 or cooperation of the two, frequency control and stability (that is, phase-locked measurement) may be achieved, the measurement may be performed accurately even when the light signal is weak, the measurement sensitivity of hemoglobin may be improved, and samples to be measured with lower concentrations and wider concentration ranges may be accurately detected. Based on this, the hemoglobin solution to be measured in this example is a dilute solution with a concentration less than 0.01 mol/L.

The above device will be explained in detail below with reference to specific examples.

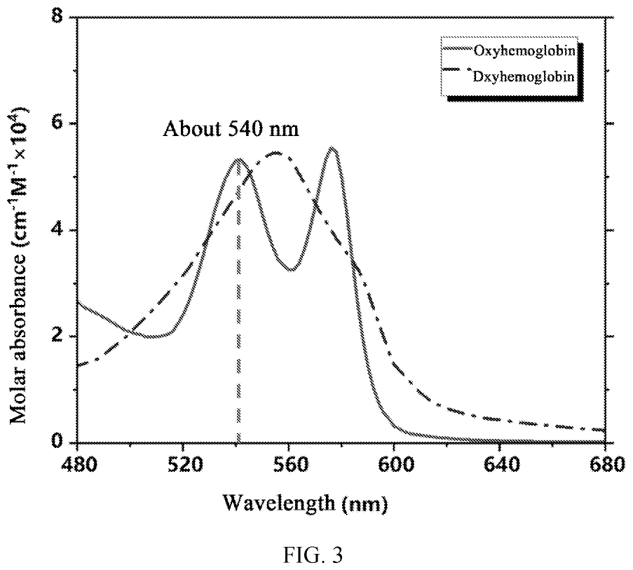

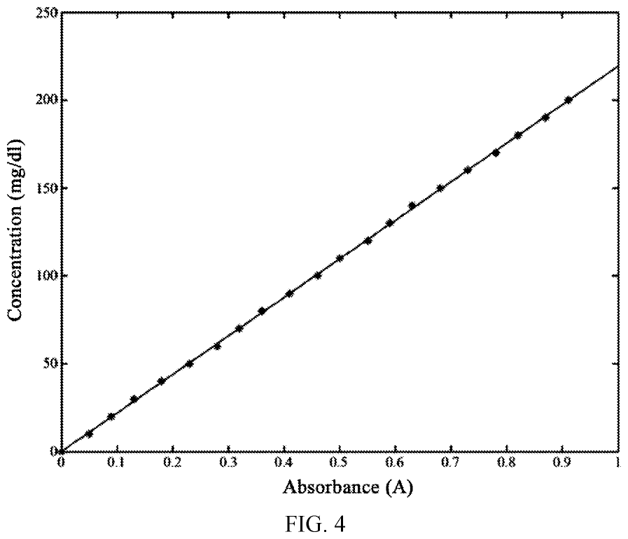

In this example, laser with a wavelength of 540 nm, which has large absorbance of hemoglobin and strong penetrating power in tissue fluid, is used as a laser source for measuring the concentration of hemoglobin, as shown in FIG. 3. The pumping source 11 has a working wavelength of 976 nm, the pumping has an output power of 250 mW, and the DBR fiber laser resonator 12 has a central wavelength of 1080 nm. The pumping source 11 emits a pumping light into the DBR fiber laser resonator 12 in a forward pumping mode to generate a stimulated radiation laser signal, the laser signal passes through the wavelength division multiplexer 13 and the optical isolation filter 14 and then enters the phase modulator 15 to output a modulated light with a wavelength of 1080 nm, then undergoes power amplification by the fiber amplifier 16 and then enters the frequency doubling module 17 to output a pure single-frequency fiber laser with a wavelength of 540 nm. The output light is split into a measurement light and a reference light by the light-splitting coupler 2 (in this example, a light intensity of the measurement light is the same as that of the reference light). After the two beams of light are collimated, after being vertically incident on the sample to be measured which is placed in the sample cell 3 with a constant thickness of L, the measurement light is received by the first photodetector 4 and converted into an electrical signal, the reference light is directly converted into an electrical signal by the second photodetector 5 after passing through the same optical path as the measurement light, the electrical signals are subjected to I/V conversion and amplification by the dual-channel signal collection and processing system 6 to obtain Vₒᵤₜ and Vᵢₙ respectively, which are proportional to the emergent light intensity I and the incident light intensity I₀ respectively, and the absorbance A=−lg(I/I₀)=−lg(Vₒᵤₜ/Vᵢₙ) at this concentration is obtained. Substituting the absorbance A into a functional relational expression, the concentration of hemoglobin can be obtained, as shown in FIG. 4. The functional relational expression can be obtained in the following manner: providing a sample cell having a constant thickness L, changing concentrations of samples, obtaining a C−A least squares linear fitting curve after multiple experiments, calculating a specific functional relational expression of C−A in a Lambert-Beer law formula A=KCL, measuring a absorbance A of a sample with unknown concentration, substituting the absorbance A into the expression, and obtaining a concentration C of hemoglobin.

In summary, compared with the prior art, this example has the advantages that the measurement process is simple, non-toxic and pollution-free, and is high in measurement efficiency, accurate in measurement result and good in stability, so that the concentration of hemoglobin can be continuously detected in real time, which may lay a foundation for non-invasive measurement. The single-frequency fiber laser 1 includes an fiber laser resonator 12, a phase modulator 15, an fiber amplifier 16, a frequency doubling module 17 and other important components. Firstly, the fiber laser resonator 12 is pumped by the pumping source 11 to generate a stimulated radiation signal light, frequency control and stability are achieved by one of the piezoelectric ceramic and the phase modulator 15 or cooperation of the two, and measurement is performed accurately even when the optical signal is weak. Secondly, the modulated light is injected into the fiber amplifier 16 for power amplification, and then passes through the frequency doubling module 17 to finally output single-frequency fiber laser of a blue-green light band with excellent directivity and monochromaticity. The output light is split into a measurement light and a reference light by the light-splitting coupler 2, after being vertically incident on the sample to be measured placed in the sample cell 3, the measurement light is received by the first photodetector 4 and converted into an electrical signal, the reference light is directly received by the second photodetector 5 and converted into an electrical signal, and the electrical signals are processed and converted by the dual-channel signal collection and processing system 6 to obtain an accurate concentration value of hemoglobin.

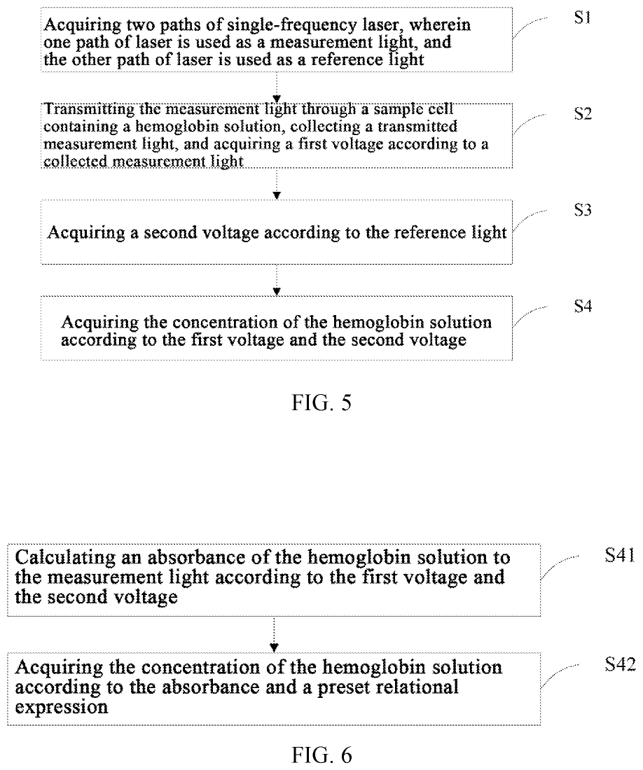

As shown in FIG. 5, this example further provides a method for measuring a concentration of hemoglobin, including following steps:
S1, acquiring two paths of single-frequency laser, where one path of laser is used as a measurement light, and the other path of laser is used as a reference light;
S2, transmitting the measurement light through a sample cell containing a hemoglobin solution, collecting a transmitted measurement light, and acquiring a first voltage according to a collected measurement light;
S3, acquiring a second voltage according to the reference light; and
S4, acquiring the concentration of the hemoglobin solution according to the first voltage and the second voltage.

See FIG. 6, step S4 includes steps S41-S42:
S41, calculating an absorbance of the hemoglobin solution to the measurement light according to the first voltage and the second voltage; and
S42, acquiring the concentration of the hemoglobin solution according to the absorbance and a preset relational expression.

The method in this example may be implemented using the above-mentioned measurement device. In this example, two paths of laser with the same light intensity are acquired, one path of laser is used as a measurement light, and the other path of laser is used as a reference light. The measurement light is vertically incident on the sample placed in the sample cell, after being transmitted through the hemoglobin solution to be measured, the measurement light is received by the first photodetector and converted into a current signal, the reference light directly enters the second photodetector after passing through the same optical path as the measurement light and is converted into a current signal, the current signals are subjected to I/V conversion and amplification by the dual-channel signal collection and processing system to obtain voltage signals Vₒᵤₜ and Vᵢₙ respectively, which are proportional to the emergent light intensity I and the incident light intensity I₀ respectively, and the absorbance A=−lg(I/I₀
)=−lg(Vₒᵤₜ/Vᵢₙ) at this concentration is obtained. The concentration C of the hemoglobin solution can be obtained according to the absorbance A and a preset relational expression.

The preset relational expression can be obtained in the following manner: providing a sample cell having a constant thickness L, changing concentrations of samples, and obtaining a C−A least squares linear fitting curve after multiple experiments, calculating a specific functional relational expression of C−A in a Lambert-Beer law formula A=KCL, measuring the absorbance A of a sample with unknown concentration, substituting the absorbance A into the expression, and obtaining the concentration C of hemoglobin.

In some alternative examples, the functions/operations mentioned in the block diagram may occur out of the order mentioned in the operation diagram. For example, two blocks shown in succession may actually be executed substantially simultaneously or the blocks may sometimes be executed in the reverse order, depending on the functions/operations involved. Furthermore, the embodiments presented and described in the flow chart of the present disclosure are provided by way of example for the purpose of providing a more comprehensive understanding of the technology. The disclosed method is not limited to the operations and logical flows presented herein. Alternative examples are contemplated, where the order of various operations is changed and where sub-operations described as part of a larger operation are performed independently.

Furthermore, although the present disclosure is described in the context of functional modules, it should be understood that, unless otherwise specified, one or more of the described functions and/or features may be integrated in a single physical device and/or or software module, or one or more functions and/or features may be implemented in separate physical devices or software modules. It will also be understood that a detailed discussion regarding the actual implementation of each module is not necessary to understand the present disclosure. More specifically, the actual implementation of this module will be understood within the ordinary skill of an engineer, taking into account the properties, functions and internal relationships of various functional modules in the device disclosed herein. Therefore, those skilled in the art can implement the present disclosure set forth in the claims without undue experimentation using ordinary skills. It will also be understood that the specific concepts disclosed are illustrative only and are not intended to limit the scope of the present disclosure, which is determined by the full scope of the appended claims and their equivalents.

In the above description of this specification, the description of the terms “one embodiment/example”, “another embodiment/example” or “certain embodiments/examples” etc. means that specific features, structures, materials or characteristics described in connection with the embodiment or example are included in at least one embodiment or example of the present disclosure. In this specification, schematic representations of the above terms do not necessarily refer to the same embodiment or example. Furthermore, the specific features, structures, materials or characteristics described may be combined in any suitable manner in any one or more embodiments or examples.

Although embodiments of the present disclosure have been shown and described, those skilled in the art will understand that various changes, modifications, substitutions and variations can be made to these embodiments without departing from the principles and purposes of the present disclosure, and the scope of the present disclosure is defined by the claims and their equivalents.

The above is a detailed description of the preferred implementation of the present disclosure, but the present disclosure is not limited to the above-mentioned embodiments. Those skilled in the art can also make various equivalent modifications or substitutions without departing from the gist of the present disclosure. These equivalent modifications or substitutions are all included within the scope defined by the claims of the present disclosure.

1. A device for measuring a concentration of hemoglobin, comprising:
a single-frequency fiber laser configured for outputting a single-path laser;
a light-splitting coupler connected to the single-frequency fiber laser and configured for splitting the single-path laser output into two paths of laser, wherein one path of laser is a measurement light, and the other path of laser is a reference light;
a first photodetector configured for receiving the measurement light transmitting through a sample cell and outputting a first voltage, wherein the sample cell contains a hemoglobin solution;
a second photodetector configured for receiving the reference light and outputting a second voltage; and
a signal collection and processing system electrically connected to the first photodetector and the second photodetector, and configured for receiving the first voltage and the second voltage and acquiring the concentration of the hemoglobin solution according to the first voltage and the second voltage.

2. The device for measuring the concentration of hemoglobin according to claim 1, wherein the single-frequency fiber laser comprises a pumping source, an fiber laser resonator, a wavelength division multiplexer, an optical isolation filter, an fiber amplifier and a frequency doubling module which are connected in sequence; and
the pumping source emits a pumping light into the fiber laser resonator to generate a stimulated radiation laser signal, and the stimulated radiation laser signal passes through the wavelength division multiplexer and the optical isolation filter and then undergoes power amplification by the fiber amplifier and frequency nonlinear conversion by the frequency doubling module to output a single-frequency fiber laser.

3. The device for measuring the concentration of hemoglobin according to claim 2, wherein the single-frequency fiber laser further comprises a phase modulator, an input of the phase modulator is connected to an output of the optical isolation filter, and an output of the phase modulator is connected to an input of the fiber amplifier; and
the phase modulator is configured for phase modulating a laser signal output by the optical isolation filter.

4. The device for measuring the concentration of hemoglobin according to claim 2, wherein the fiber laser resonator is additionally provided with a piezoelectric ceramic configured for phase modulating an output light of the fiber laser resonator.

5. The device for measuring the concentration of hemoglobin according to claim 2, wherein the pumping source has a working wavelength of 976 nm, the fiber laser resonator has a central wavelength of 1080 nm, and the frequency doubling module outputs a single-frequency fiber laser with a wavelength of 540 nm.

6. The device for measuring the concentration of hemoglobin according to claim 2, wherein a frequency doubling crystal in the frequency doubling module is a lithium niobate crystal, a magnesium oxide-doped lithium niobate crystal, a lithium tantalate crystal, a lithium triborate crystal, a barium metaborate crystal, a potassium dihydrogen phosphate crystal or a potassium titanyl phosphate crystal.

7. The device for measuring the concentration of hemoglobin according to claim 1, wherein a wavelength range of an output light of the single-frequency fiber laser is 450 nm to 580 nm.

8. A method for measuring a concentration of hemoglobin, comprising following steps:
acquiring two paths of single-frequency laser, wherein one path of laser is used as a measurement light, and the other path of laser is used as a reference light;
transmitting the measurement light through a sample cell containing a hemoglobin solution, collecting a transmitted measurement light, and acquiring a first voltage according to a collected measurement light;
acquiring a second voltage according to the reference light; and acquiring the concentration of the hemoglobin solution according to the first voltage and the second voltage.

9. The method for measuring the concentration of hemoglobin according to claim 8, wherein the step of acquiring the concentration of the hemoglobin solution according to the first voltage and the second voltage comprises:
calculating an absorbance of the hemoglobin solution to the measurement light according to the first voltage and the second voltage; and
acquiring the concentration of the hemoglobin solution according to the absorbance and a preset relational expression.

10. The method for measuring the concentration of hemoglobin according to claim 9, wherein the preset relational expression is obtained in the following manner:
providing a sample cell having a constant thickness;
filling a hemoglobin solution with a preset concentration into the sample cell, collecting the reference light and the measurement light transmitting through the sample cell, and calculating an absorbance corresponding to the hemoglobin solution with the preset concentration according to collected measurement light and reference light; and
by changing concentrations of hemoglobin solutions, acquiring the absorbances corresponding to the hemoglobin solutions at different concentrations, and obtaining the relational expression.

11. The device for measuring the concentration of hemoglobin according to claim 3, wherein the fiber laser resonator is additionally provided with a piezoelectric ceramic configured for phase modulating an output light of the fiber laser resonator.
